(19) United States
(12) Patent Application Publication
(10) Pub. No.: US 2026/0362230 A1
(43) Pub. Date: Nov. 12, 2026

(54) TECHNIQUES FOR ENHANCING WIRELESS LOCAL AREA NETWORK (WLAN) BUFFER STATUS REPORTS TO INDICATE L4S QUEUE STATUS

(71) Applicant: Cisco Technology, Inc., San Jose, CA (US)

(72) Inventors: Robert Edgar Barton, Richmond (CA); Jerome Henry, Pittsboro, NC (US); Binita Gupta, San Diego, CA (US); Juan Carlos Zuniga, Montreal (CA)

(21) Appl. No.: 19/262,683

(22) Filed: Jul. 8, 2025

Related U.S. Application Data
(60) Provisional application No. 63/800,524, filed on May 6, 2025.

(51) Int. Cl. H04W 28/02; H04W 84/12

(52) U.S. Cl. CPC H04W 28/0278; H04W 84/12

(57) ABSTRACT

Embodiments herein provide techniques for an enhanced wireless Institute of Electrical and Electronics Engineering (IEEE) 802.11 (Wi-Fi®) Buffer Status Report (BSR) that may be utilized to inform a wireless local area network (WLAN) access point (AP) of Low Latency, Low Loss, Scalable Throughput (L4S) queue status. In at least one embodiment, a method may include determining, by a wireless device, queue status for a plurality of L4S queues maintained by the wireless device; determining queue status for a plurality of non-L4S queues maintained by the wireless device; and transmitting a BSR to an AP of the WLAN, the BSR including the queue status for at least one L4S queue of the plurality of L4S queues maintained by the wireless device.

This application claims the benefit of priority under 35 U.S.C. § 119 to U.S. Provisional Application No. 63/800,524, filed May 6, 2025, the entirety of which is incorporated herein by reference.

### TECHNICAL FIELD

The present disclosure relates to wireless network equipment and services.

### BACKGROUND

Networking architectures have grown increasingly complex in communications environments, particularly wireless networking environments. For wireless local area networks (WLANs), Institute of Electrical and Electronics Engineers (IEEE) 802.11 specifications are working towards the definition of Low Latency, Low Loss, Scalable Throughput (L4S) mechanisms for implementation via WLAN access points (APs) and client devices or stations (STAs). Thus, there are new challenges and opportunities with regard to L4S solutions that can be provided for WLAN APs and STAs.

### BRIEF DESCRIPTION OF THE DRAWINGS

FIG. 1A is a diagram illustrating a system that may be implemented to utilize enhanced wireless local area network (WLAN) Buffer Status Reports (BSRs) to inform a WLAN access point (AP) regarding Low Latency, Low Loss, Scalable Throughput (L4S) queue status of a wireless device, according to an example embodiment.

FIG. 1B is a diagram illustrating example details for implementing L4S queues for multiple access categories (ACs), according to an example embodiment.

FIG. 2A is a diagram illustrating details for a conventional BSR.

FIG. 2B is a diagram illustrating example details for an enhanced BSR that can be used to report status for at least one L4S queue maintained by a station (STA), according to an example embodiment.

FIG. 2C is a diagram illustrating example details for another enhanced BSR that can be used to report status for at least one L4S queue maintained by a station (STA), according to an example embodiment.

FIG. 3 is a flowchart depicting a method according to an example embodiment.

FIG. 4 is a flowchart depicting a method according to an example embodiment.

FIG. 5 illustrates a hardware block diagram of a computing device configured to perform functions associated with operations discussed in connection with embodiments herein.

### DETAILED DESCRIPTION

### Overview

Embodiments herein provide techniques for enhancing wireless Institute of Electrical and Electronics Engineering (IEEE) 802.11 (Wi-Fi®) Buffer Status Report (BSRs) transmitted by a wireless device or station (STA) to a wireless local area network (WLAN) AP to inform the WLAN AP of Low Latency, Low Loss, Scalable Throughput (L4S) queue status for one or more L4S queues maintained by the STA. Broadly, embodiments herein may facilitate reporting L4S-specific BSR information via enhanced BSRs that may include queue size details and/or any other metrics for L4S queues maintained by a given STA. In various embodiments, enhanced BSRs can be used by a given STA to inform an AP regarding how many packets or bits/bytes are contained/buffered in at least one L4S queue versus at least one non-L4S (classic) queue so that the AP can assign or schedule Resource Units (RUs) and Transmission (or Transmit) Opportunities (TXOPs) for the given STA.

In some aspects, the techniques described herein relate to a method including: determining, by a wireless device within a wireless local area network (WLAN), queue status for a plurality of Low Latency, Low Loss, Scalable Throughput (L4S) queues maintained by the wireless device; determining, by the wireless device within the WLAN, queue status for a plurality of non-L4S queues maintained by the wireless device; and transmitting a buffer status report (BSR) to an access point (AP) of the WLAN, the BSR including the queue status for at least one L4S queue of the plurality of L4S queues maintained by the wireless device.

In some aspects, the techniques described herein relate to a method including: obtaining, by an access point (AP) of a wireless local area network (WLAN), a buffer status report (BSR) from a wireless device of the WLAN, the BSR including queue status for at least one Low Latency, Low Loss, Scalable Throughput (L4S) queue of a plurality of L4S queues maintained by the wireless device for a plurality of access categories; and scheduling, by the AP, Resource Units (RUs) or Transmit Opportunities (TXOPs) for the wireless device based on the queue status for the at least one L4S queue.

### Example Embodiments

In a wireless local area network (WLAN), such as an IEEE 802.11 (Wi-Fi®) network, one or more wireless APs provide wireless Radio Frequency (RF) coverage over which one or more wireless devices (e.g., phones, wearable devices, tablets, etc.), often referred to as wireless client devices or stations (STAs) can connect to the APs in order to connect to one or more data networks (e.g., the public Internet, an enterprise network operated by an enterprise entity (e.g., a business, institution, university, etc.)), and/or the like.

Low Latency, Low Loss, Scalable Throughout (L4S) is an architecture and protocol suite defined by the Internet Engineering Task Force (IETF), such as through Request for Comments (RFCs) 9330, 9331, and 9332, with the purpose to provide low queuing latency, low packet loss, and scalable throughput control for all manner of real-time applications (e.g., streaming video, multiplayer games, and/or other real-time applications).

L4S is a congestion management technology that significantly improves application performance without dropping packets and allows networks to interact with applications and hosts to influence the bitrate of data streams when congestion is detected. In recent years, many vendors have started to adopt L4S mechanisms in different environments.

The IEEE standards body is currently exploring solutions related to how the L4S queuing mechanism may be implemented in 802.11/WLAN APs and STAs. Ultimately, the 802.11 Media Access Control (MAC) layer may not change significantly, meaning that existing Access Categories (ACs) may be re-purposed for the use of the L4S and classic queues.

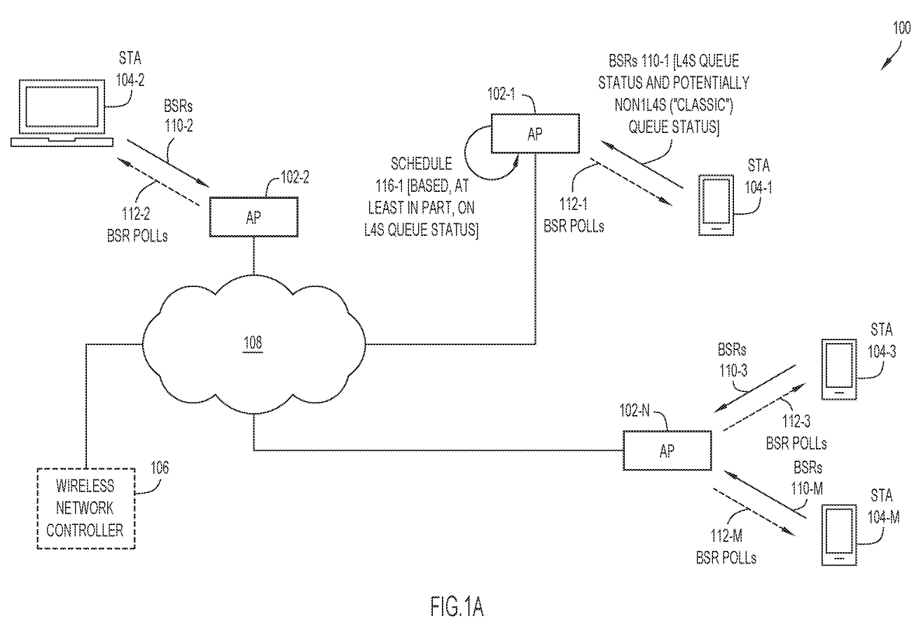

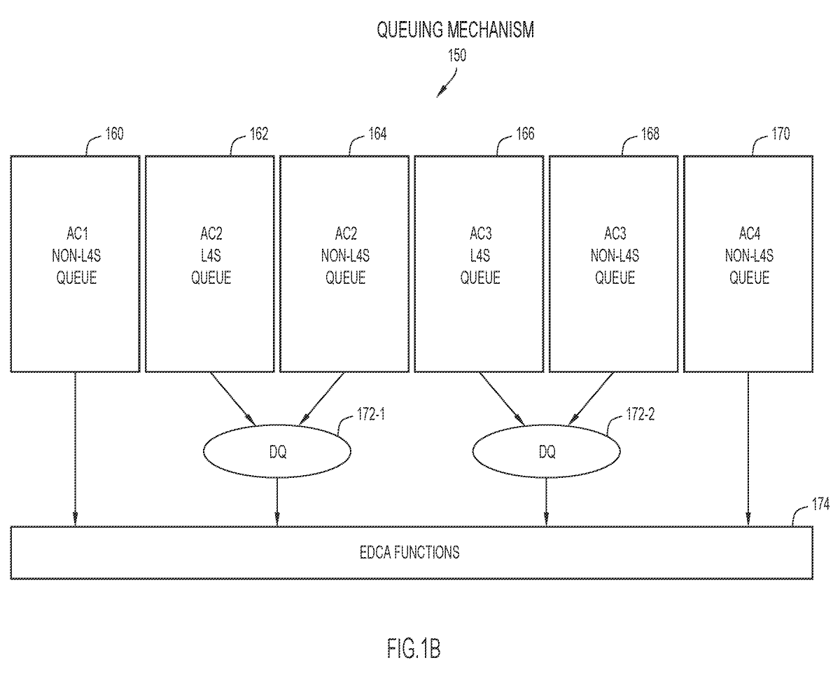

Referring to FIG. 1A, FIG. 1A is a block diagram of a system 100 that may be implemented to utilize enhanced WLAN BSRs to inform a WLAN access point (AP) regarding L4S queue status of a wireless device (also referred to herein as a client device, station (STA), or the like), according to an example embodiment. Generally, system 100 illustrates a WLAN/802.11 network environment. In at least one embodiment, system 100 may include a number of WLAN APs, such as an AP 102-1, an AP 102-2, through an AP 102-N, and a number of wireless devices (STAs) that can exchange wireless communications with the APs, such as a STA 104-1, a STA 104-2, a STA 104-3, through a STA 104-M shown in FIG. 1A.

Also shown in FIG. 1A is a network 108. In some embodiments, system 100 may include a wireless network controller 106, sometimes referred to as a wireless LAN controller (WLC). Network 108 may be inclusive of any combination of wired and/or wireless networks through which communications can be exchanged between the APs 102-1 – 102-N and/or wireless network controller 106, if implemented.

Each AP 102-1 – 102-N can include any WLAN/802.11 hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) to facilitate WLAN RF coverage (for any WLAN/802.11 variant, such as 802.11ax (Wi-Fi 6/6E), 802.11be (Wi-Fi 7), 802.11bn (Wi-Fi 8), etc.) for system 100. In at least one embodiment, wireless network controller 106 (if implemented) can facilitate communications among APs 102-1 – 102-N and/or control/management of APs 102-1 – 102-N.

Each STA 104-1 – 104-M may be inclusive of any wireless device, may be considered any electronic device, etc. that initiates a connection or communication session with a corresponding network, and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, a cellular/WLAN enabled device, and/or any other device, component, element, or object capable of performing wireless voice, audio, video, media, or data exchanges within a system. Thus, a STA or wireless device may include any hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) in order to connect to one or more radio nodes/APs of one or more radio access networks(s) including WLAN/802.11 access networks (for any WLAN/802.11 variant).

In modern 802.11 networks, an AP can schedule uplink communication for STAs (connected to/associated to the AP) using orthogonal frequency-division multiple access (OFDMA) wireless communications. An AP can use Buffer Status Reports (BSRs) received from to determine out how much data is currently sitting in each STA’s buffer, also referred to herein as a queue. The AP can then use this information to schedule both Resource Units (RUs), as well as Transmission (or Transmit) Opportunities (TXOPs) during a next transmission cycle so that a STA can be adequately serviced.

While BSRs today can report on the amount of data in each of a number of Access Category (AC) queues maintained by a STA, there is no mechanism currently provided for using the BSR to report on how much L4S queue data versus non-L4S queue data may be present in each AC queue that may be maintained by a STA.

However, it would be advantageous for an AP to know the L4S versus non-L42 queue status of a STAs so that the AP can schedule RUs and TXOPs for STAs based on their L4S queue status. For example, based on knowing the L4S queue status for a given STA (e.g., the amount of traffic or data buffered in a given L4S queue), an AP could schedule wider RUs for the given STA or could schedule more TXOPs for the given STA.

Embodiments herein introduce one or more enhancements to BSR(s) that a STA can utilize to inform an AP of L4S queue status, which may improve scheduling by an AP and/or may provide other improvements for 802.11/WLAN networks. As referred to herein, a non-L4S buffer or queue can also be referred to as a "classic" or "conventional" queue or buffer in which each of a corresponding non-L4S queue can be provided for each of a corresponding AC.

FIG. 1B is a diagram illustrating example details for implementing L4S and non-L4S queues for STAs 104-1–104-M of system 100. Each STA 104-1 – 104-M can include a corresponding queuing mechanism, such as a queuing mechanism 150 as shown in FIG. 1B. In at least one embodiment, one or more of APs 102-1–102-N can also include a corresponding L4S and non-L4S queueing mechanism, such as a queuing mechanism 150 as shown in FIG. 1B.

In many cases, the L4S and classic queues will likely share use of the existing ACs. For example, the queuing mechanism 150 can include a first AC non-L4S queue 160, a second AC L4S queue 162, a second AC non-L4S queue 164, a third AC L4S queue 166, a third AC non-L4S queue 168, and a fourth AC non-L4S queue 170. In some embodiments, the first AC is a background AC (AC_BK), the second AC is a best effort AC (AC_BE), the third AC is a video AC (AC_VI), and the fourth AC is a voice AC (AC_VO). The best effort AC and the video AC may include both a non-L4S (classic) queue and a L4S queue because the best effort AC and the video AC can manage a mix of L4S flows and non-L4S/classic flows. However, different ACs can have both a non-L4S queue and an L4S queue in some embodiments.

The queuing mechanism 150 may also include Distributed Queuing (DQ) switches, such as a DQ switch 172-1 and a DQ switch 172-2. The second AC L4S queue 162 and the second AC non-L4S queue 164 can both send queued traffic from the queues to DQ switch 172-1, and the third AC L4S queue 166 and the third AC non-L4S queue 168 can send the queued traffic from the queues to DQ switch 172-2. The queuing mechanism 150 also includes Enhanced Distributed Channel Access (EDCA) functions 174 for the first AC non-L4S queue 160, DQ switch 172-1, DQ switch 172-2, and the fourth AC non-L4S queue 170 to send queued traffic for subsequent transmission toward an AP. In at least one embodiment, the queuing mechanism 150 can be implemented at a Media Access Control (MAC) layer of a given STA to enable control for L4S flow scheduling with low queuing delay and high output.

In at least one embodiment, each L4S queue can be a shallow queue and with low delay, so that each L4S queue can benefit from specific transmitting conditions. In some embodiments, frames in an L4S queue are transmitted using typical EDCA rules (e.g., according to EDCA rules for Arbitration Inter-Frame Spacing Number (AIFSN), Minimum Contention Window (CWmin), Maximum Contention Window (CWmax), retries, etc.).

In at least one embodiment, the queuing mechanism 150 can be implemented as an L4S Dual Queue (Dual-Q or DualQ) Active Queue Management (AQM) mechanism or algorithm. The L4S Dual-Q AQM mechanism or algorithm may provide for the ability to both mark L4S Explicit Congestion Notification (ECN) codepoints, as well as to manage the allocation of resources for both the non-L4S ("classic") and L4S queues in the presence of congestion. In some embodiments, other queuing mechanisms/algorithms can be used including, but not limited to, Weighted Fair Queue (WFQ), Class Based Queueing (CBQ), and/or generic EDCA or Hybrid Coordination Function (HCF) Controlled Channel Access (HCCA).

An L4S queue is intended to be shallow – this is because the Explicit Congestion Notification (ECN) mechanism is designed to signal between sender-receiver (client-server) that congestion is detected and to slow down the bitrate, theoretically keeping packets out of a shallow L4S queue. In reality, however, this may not always be the case, and an L4S queue may function as designed when congestion builds up – that is, when the client-receiver bitrate is still not low enough, packets may be forced to pile up in the queue.

In current/conventional WLANs, an AP can send a BSR poll to a STA asking the STA to report the total number of bits sitting in the buffer for each AC via a BSR, referred to as a solicited BSR. A STA can also send an unsolicited BSR to an AP in some instances, for example, to inform the AP that there is data that needs to be transmitted upstream to the AP. The AP can use this report to schedule uplink time and space (RUs) for the STA.

In augmentation to current/conventional BSR mechanisms, embodiments herein include one or more techniques for enhancing BSRs and/or BSR mechanisms such that a STA can inform an AP of the L4S queue status for at least one L4S queue maintained by the STA via an enhanced BSR, as generally shown in FIG. 1A.

For example, as illustrated in FIG. 1A, a given STA, such as STA 104-1, can send one or more BSRs 110-1 to AP 102-1 informing the AP 102-1 regarding the status for at least one L4S queue maintained by the STA 104-1. In some embodiments, the one or more BSRs 110-1 may also include the status for at least one non-L4S (classic) queue maintained by the STA 104-1.

In some embodiments, the STA 104-1 can send one or more BSRs 110-1 to AP 102-1 that are solicited based on receiving one or more BSR polls 112-1 (BSRP(s)) from the AP 102-1 requesting L4S queue status from the STA 104-1, which can include enhanced BSRPs as discussed for embodiments herein or conventional BSRPs as discussed herein. In some embodiments, STA 104-1 can send one or more BSRs 110-1 to AP 102-1 that are unsolicited and natively include L4S queue status and potentially non-L4S queue status.

In various embodiments, L4S queue status for one or more L4S queues reported via a BSR can include, but not be limited to, a number of packets stored in the one or more L4S queues, a number of bits/bytes/octets stored in the one or more L4S queues, one or more corresponding ACs associated with the one or more corresponding L4S queues, an amount of data/packets/bits/bytes overwritten in one or more L4S queues since a last BSR was reported for the one or more L4S queues or for some other period of time, a number of (transmitted) TCP ACKs (Transmission Control Protocol Acknowledgments) or QUIC (Quick User Datagram Protocol (UDP) Internet Connections) packets that were marked with ECN/congestion, a number of packets (or bytes/octets) received or sent in/from a given L4S queue over a given interval, the number of ECN marked packets per L4S queue and per interval, and/or any other detailed characteristics of L4S condition(s), recent history and/or L4S metrics that may be associated with/utilized for reporting L4S queue status.

Receiving L4S queue status (as well as non-L4S queue status) from the STA 104-1 via one or more BSRs 110-1 can provide AP 102-1 with a clearer picture of the L4S and non-L4S queue conditions experienced by STA 104-1, which can impact scheduling performed by AP 102-1 regarding transmissions for STA 104-1, as generally shown at 116-1. In at least one embodiment, the scheduling as shown at 116-1 for STA 104-1 performed by AP 102-1 based, at least in part, on the L4S queue status obtained by the AP 102-1, can cause the AP 102-1 to schedule more TXOPs for the STA 104-1. In at least one embodiment, the scheduling as shown at 116-1 for STA 104-1 performed by AP 102-1 based, at least in part, on the L4S queue status obtained by the AP 102-1, can cause the AP 102-1 to schedule wider RUs for STA 104-1 to allow more data transmission to be performed by the STA 104-1.

Resource units (RUs) are typically 2 megahertz (MHz) wide per unit. For example, if one RU is allocated to a flow, then the sender has only 2 MHz of frequency bandwidth space in which to send encoded data, which limits the amount of data that can be represented in that space. Allocating 2 RUs (approximately 4 MHz) doubles the frequency bandwidth space; thus, mechanically, the throughput of the transmission for that sender is increased. As such, scheduling wider RUs can be characterized as giving more bandwidth to a given flow.

Consider, for example, a scenario in which a sender is transmitting a video flow of a given video coder/decoder, referred to in this example as 'CODEC A', in which the video flow is high quality but also involves high bandwidth consumption. In this example, if a narrow RU is scheduled, the sender may not have enough space to encode the entire image into each transmission, causing the sender to use multiple TXOPs to send a given image. Meanwhile, the L4S queue/buffer for this AC continues to fill up with images in waiting. In turn, the video application reads that the buffer is filling up and concludes that the bandwidth is insufficient, and reverts to a worse but less intensive CODEC, say 'CODEC B'. However, if more RU space is provided/allocated to the sender, more bandwidth can be used to send the video data such that the amount of data in the queue/buffer can start to decrease. As the application determines that the transmit (Tx) queue remains near an empty level, the application can switch back to the better (but more bandwidth intensive) CODEC, CODEC A.

Regarding TXOPs, if the sender, for a fixed RU allocation, sporadically receives one TXOP and then receives another TXOP at some later time, the given L4S queue can fill-up, causing the CODEC to be changed to something less bandwidth intensive (e.g., CODEC B). However, if the sender receives more TXOPs, i.e., more opportunities to transmit (more often), then the queue empties faster, allowing the application to conclude that a better CODEC is possible (e.g., CODEC A).

Thus, an AP can determine to schedule wider RUs and/or more TXOPs based on obtaining L4S queue status from a given STA.

In at least one embodiment, an AP may keep or otherwise maintain a record in a time-series of the L4S and non-L4S queue metrics each time a BSR is received from a given STA. In at least one embodiment, the AP can use this data to track changes and rate-of-changes in L4S behavior in the given STA and can use this to predict future L4S demands from the given STA and/or can proactively schedule greater resources (RUs and/or TXOPs) for the given STA.

Similarly for system 100, STA 104-2 can transmit one or more BSRs 110-2 to AP 102-2 (solicited, based on BSR polls 112-2, or unsolicited) in which the one or more BSRs 110-2 include L4S queue status, and potentially non-L4S queue status for STA 104-2 that can impact scheduling, etc., performed by AP 102-2 regarding STA 104-2 transmissions. Further, STA 104-3 can transmit one or more BSRs 110-3 to AP 102-N (solicited, based on BSR polls 112-3 (enhanced BSRPs or conventional BSRPs), or unsolicited) in which the one or more BSRs 110-3 include L4S queue status, and potentially non-L4S queue status for STA 104-3 that can impact scheduling, etc., performed by AP 102-N regarding STA 104-3 transmissions. And so on for system 100 through STA 104-M, which can transmit one or more BSRs 110-M to AP 102-N (solicited, based on BSR polls 112-M (enhanced or conventional), or unsolicited) in which the one or more BSRs 110-M can include L4S queue status, and potentially non-L4S queue status for STA 104-3 that can impact scheduling, etc., performed by AP 102-N regarding STA 104-3 transmissions.

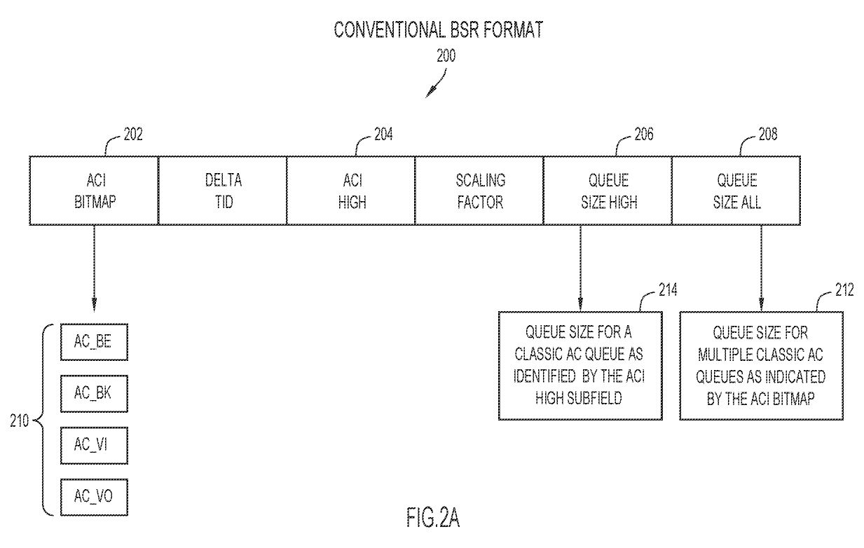

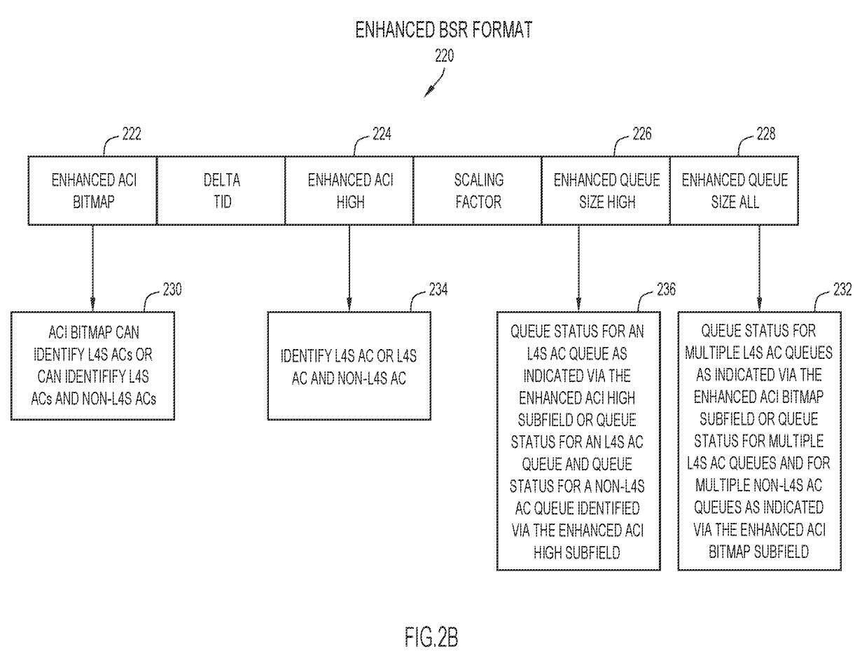

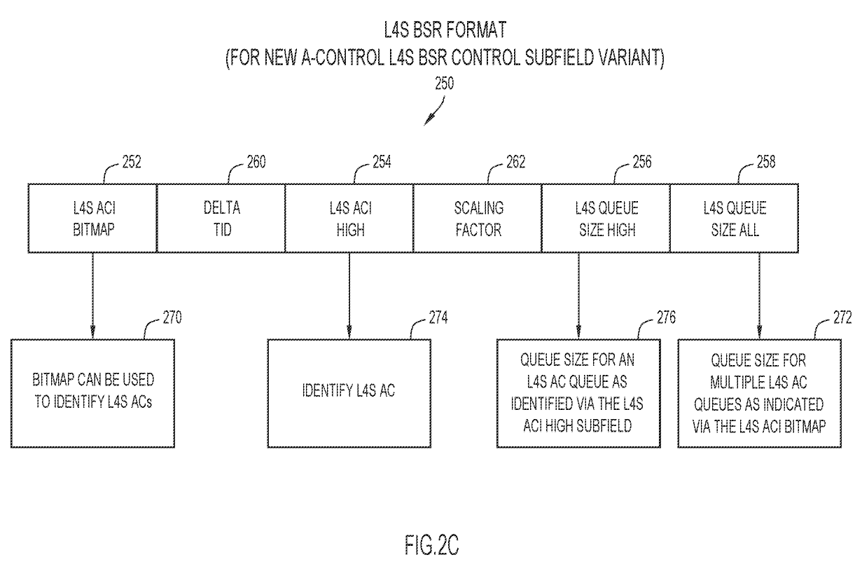

Various embodiments regarding enhanced BSRs that can be used to report status for at least one L4S queue maintained by a given STA (e.g., any STA 104-1 through 104-M), and potentially to report status for at least one non-L4S queue maintained by the given STA are described in further detail below with reference at least to FIGS. 2B and 2C.

FIG. 2A is a diagram illustrating details for a conventional BSR format 200, as prescribed by Section 9.2.4.7.4 of IEEE 802.11-REVme/D7.0, published Aug. 2024. The conventional BSR format 200 is provided as a BSR Control subfield variant within the group of aggregated control (A-Control) subfield variants (specified via Section 9.2.4.7) that can be included in a MAC frame transmitted by a given STA. IEEE standards also define MAC frame formats for high throughput/high efficiency (HT/HE) communications, as provided via Section 9.2.4.6.4, which also includes various A-Control subfield variants that can be identified via a control ID subfield (4-bits) and control information subfield (variable length). Per IEEE 802.11-REV/me/D7.0, a BSR reported via an HT/HE MAC frame is to adhere to the conventional BSR format 220, as defined via Section 9.2.4.7.4.

As illustrated in FIG. 2A, the conventional BSR format 200 includes an access category index (ACI) Bitmap subfield 202, an ACI High subfield 204, a Queue Size High subfield 206, and a Queue Size All subfield 208.

The conventional BSR format 200 can be used to report buffer/queue status for any combination of one or more corresponding non-L4S/classic AC buffers/queues as maintained by a given STA allowing a given AP to know how much data of various priorities need to be transmitted by the STA.

For instance, the ACI Bitmap subfield 202 can include a bitmap 210 of encoding bits, any of which can be set to '1' indicating the corresponding ACs (AC_BE, AC_BK, AC_VI, and AC_VO) for which queue/buffer status for the corresponding classic AC queues maintained by a given STA are reported in a given BSR via the Queue Size All subfield 208, as shown at 212. Thus, the Queue Size All subfield 208 can be used to report queue status for multiple classic queues in which the queue status reported for the classic AC queues can be indicated in bits or octets (e.g., Scaling Factor (SF) octets).

The ACI High subfield 204 can be used to indicate the ACI of the AC for which buffer/queue status for a corresponding classic AC queue is reported via a given BSR via the Queue Size High subfield 206, as shown at 214. Thus, the Queue Size High subfield 206 can be used to report queue status for a single classic queue, as identified via the ACI High subfield 204, in which the queue status reported for the classic AC queue can be indicated in bits or octets (e.g., SF octets).

Other subfields, such as a Delta TID subfield and a Scaling Factor (SF) subfield are shown for the conventional BSR format 200, which can include information as prescribed by Section 9.2.4.7.4.

As provided through embodiments herein, in at least one embodiment, L4S queue status information may be reported via an enhanced BSR that can be used to report queue status for any combination of L4S queues and/or non-L4S queues maintained by a given STA for any combination of ACs, as described in further detail herein, below, with reference at least to FIG. 2B. In at least one embodiment, L4S queue status information may be reported via a new L4S BSR Control subfield that can be defined as described in further detail herein, below, with reference at least to FIG. 2C.

Turning FIG. 2B, FIG. 2B is a diagram illustrating example details for an enhanced BSR format 220 that can be used to report status for at least one L4S queue maintained by a station (STA), according to an example embodiment. The enhanced BSR format 220 can be utilized via HT/HE MAC frames or non-HT/HE MAC frames in accordance with embodiments herein.

Multiple potential enhancements to the conventional BSR format are described for FIG. 2B, thus, it is to be understood that any of the enhancements to the BSR format as described for embodiments herein can be used in any combination in accordance with the broad scope of the present disclosure.

In at least one embodiment, the enhanced BSR format 220 can be configured such that existing BSR control fields for the existing BSR Control subfield variant can be enhanced to indicate that BSR information is provided only for L4S queues maintained by a given STA. In at least one embodiment, the enhanced BSR format 220 can be configured such that the existing BSR Control Information subfield in the existing BSR Control subfield can be enhanced to provide queue status for both L4S and non-L4S queues.

In various embodiments, the enhanced BSR format 220 can include any combination of an enhanced ACI Bitmap subfield 222, an enhanced ACI High subfield 224, an enhanced Queue Size High subfield 226, and/or an enhanced Queue Size All subfield 228 in order to facilitate reporting any combination of L4S and potentially also non-L4S queue status by a given STA.

In some embodiments, the enhanced ACI Bitmap subfield 222 can include an ACI bitmap that can be enhanced to indicate L4S queue status (e.g., size) for only L4S queues for certain ACs maintained by a given STA (e.g., L4S AC_BE and L4S AC_VE, etc.), as generally shown at 230. In some embodiments, the enhanced ACI Bitmap subfield can include an ACI bitmap that can be enhanced to indicate L4S queue status for L4S queues for certain ACs and non-L4S queue status for non-L4S queues for certain ACs maintained by a given STA, as generally shown at 230. Any of the L4S queue status or non-L4S queue status and non-L4S queue status can be reported by the given STA via the enhanced Queue Size All subfield 228, as generally shown at 232.

In some embodiments, the enhanced ACI High subfield 224 can include an indication indicating an ACI of an L4S AC for which corresponding L4S queue status is being reported via a given BSR, as generally shown at 234, in which the L4S queue status (for the corresponding AC) can be indicated via the enhanced Queue Size High subfield 226, as generally shown at 236. In some embodiments, the enhanced ACI High subfield 224 can include indication(s) indicating an ACI of an L4S AC for which corresponding L4S queue status is being reported via a given BSR and indicating an ACI of a non-L4S AC for which corresponding non-L4S queue status is being reported via the given BSR, as generally shown at 234, in which the L4S queue status (for the corresponding AC) and the non-L4S queue status (for the corresponding AC) can be indicated via the enhanced Queue Size High subfield 226, as generally shown at 236.

In various embodiments, queue status for one or more or more L4S queues and potentially one or more non-L4S queues maintained by a given STA that can be reported via an enhanced BSR formatted according to the enhanced BSR format 220 can include, but not be limited to, any combination of: a number of packets (e.g., size) stored in the one or more L4S queues and potentially non-L4S queues, a number of bits/bytes/octets (e.g., size) stored in the one or more L4S queues and potentially non-L4S queues, one or more corresponding ACs associated with the one or more corresponding L4S queues (e.g., for reporting queue size and ACs of L4S queues) and potentially non-L4S queues, an amount of data/packets/bits/bytes overwritten in the one or more L4S queues and potentially non-L4S queues since a last (enhanced) BSR was reported for the one or more L4S queues and potentially non-L4S queues or for some other period of time, a number of (transmitted) TCP ACKs or QUIC packets that were marked with ECN/congestion, and/or any other detailed characteristics of L4S condition(s), recent history and/or L4S metrics that may be associated with/utilized for reporting L4S queue status and potentially any other detailed characteristics of non-L4S condition(s), recent history and/or non-L4S metrics that may be associated with/utilized for reporting non-L4S queue status. In at least one embodiment, only a subset of this information may be sent, for example, in an enhanced BSR.

Turning to FIG. 2C, in at least one embodiment, a new A-Control subfield variant can be defined that can be used to report L4S queue status or L4S BSR information. In at least one embodiment, a new L4S BSR Control subfield can be defined as a new A-Control subfield variant that can be formatted in accordance with an L4S BSR format 250, as shown in FIG. 2C, which can be used to report L4S queue status by a given STA.

In at least one embodiment, the new L4S BSR Control subfield variant and corresponding L4S BSR format 250 can be defined as a new A-Control subfield variant or category within the list of variants provided via Section 9.2.4.7.4 of IEEE 802.11-REVme (or any other appropriate IEEE 802.11 standard/section) and can be defined as a new A-Control Control ID value (4-bit value) within the list of categories that can be identified via Section 9.2.4.6.4 (HT/HE) of IEEE 802.11-REVme (or any other appropriate IEEE 802.11 standard/section).

In at least one embodiment, one or more subfields of the L4S BSR format 250 can be defined to report L4S queue status for one or more L4S queues maintained by a given STA. In at least one embodiment, the L4S BSR format 250 can include an L4S ACI Bitmap subfield 252, an L4S ACI High subfield 254, an L4S Queue Size High subfield 256, and an L4S Queue Size All subfield 258.

In at least one embodiment, the L4S ACI Bitmap subfield 252 can include a bitmap of encoding bits, any of which can be set to '1' indicating corresponding ACs (AC_BE, AC_BK, AC_VI, and AC_VO), as shown at 270, for which L4S queue status for the corresponding L4S AC queues maintained by a given STA are reported in a given enhanced BSR. The L4S queue status can be reported via the L4S Queue Size All subfield 252, as shown at 272. Thus, the L4S Queue Size All subfield 258 can be used to report L4S queue status for multiple L4S queues.

In at least one embodiment, the L4S ACI High subfield 254 can be used to indicate (as shown at 274) the ACI of the AC for which L4S queue status for a corresponding L4S AC queue is reported via a given enhanced BSR. The L4S queue status for the corresponding L4S AC queue can be provided via the L4S Queue Size High subfield 256, as shown at 276. Thus, the L4S Queue Size High subfield 256 can be used to report L4S queue status for a single L4S queue.

Other subfields, such as a Delta TID subfield 260 and a Scaling Factor (SF) subfield 262 can be provided for the L4S BSR format 250 and can include other L4S-specific information for the L4S queues.

In various embodiments, queue status for an L4S queue maintained by a given STA that can be reported via an enhanced BSR formatted according to the L4S BSR format 250 can include, but not be limited to, any combination of: a number of packets (e.g., size) stored in the L4S queues, a number of bits/bytes/octets (e.g., size) stored in the L4S queue, a corresponding AC associated with the corresponding L4S queue, an amount of data/packets/bits/bytes overwritten in the L4S queue since a last (enhanced) BSR was reported for the L4S queue or for some other period of time, a number of (transmitted) TCP ACKs or QUIC packets that were marked with ECN/congestion, and/or any other detailed characteristics of L4S condition(s), recent history and/or L4S metrics that may be associated with/utilized for reporting L4S queue status. In at least one embodiment, only a subset of this information may be sent, for example, in an enhanced BSR.

The enhanced BSR format 220 of FIG. 2B and the L4S BSR format 250 of FIG. 2C can be inclusive of an enhanced BSR as discussed herein that can be used to report at least L4S queue status and/or L4S information for one or more L4S queues maintained by a given STA in accordance with embodiments herein.

In at least one embodiment, an AP can issue an augmented or enhanced BSR Poll (BSRP) to a STA, asking the STA to provide L4S-specific details in a reported (enhanced) BSR to be sent to the AP—potentially in addition to default/classic (non-L4S) queue information or instead of a non-L4S queue information. In at least one embodiment, such techniques could be implemented with a simple flag setting on the BSR poll, informing the STA of the L4S detail request. For instance, in at least one embodiment, a Reserved field in the Common Info field or User Info field of the conventional BSRP frame format (as specified per IEEE 802.11-REVme/D7.0 Section 9.3.1.22.6) can be enhanced to signal a request for L4S-specific BSR/queue information to be reported by a given STA, which may be reported in addition to or instead of non-L4S queue information that may be reported by the given STA. In some embodiments, a given STA can send one or more unsolicited enhanced BSRs to an AP.

In at least one embodiment, a given STA may simply inform an AP, natively, of L4S queue status and non-L4S queue status (and potentially history thereof) each time a traditional BSR request, such as a traditional or conventional BSRP (not an enhanced BSRP), is received by the given STA.

With one or more of the enhancements provided by embodiments herein, an AP (e.g., any of AP 102-1 through 102-N of FIG. 1A) may be provided with a clearer picture of the L4S and Classic queue conditions for a STA (e.g., any of STA 104-1 through 104-M of FIG. 1A), allowing the AP to schedule more TXOP time as may be needed, or wider RUs to allow more data transmission.

In at least one embodiment, an AP may keep or otherwise maintain a record in a time-series of the L4S and/or non-L4S queue metrics each time an enhanced BSR is received from a given STA. In at least one embodiment, an AP can use such time-series data to track changes and/or rate-of-changes in L4S behavior in one or more STAs and can use this to predict future L4S demands from the one or more STAs, and/or can proactively schedule greater resources for the one or more STAs. Consider, for example, a scenario in which a given STA sends a BSR indicating 2packets (of 160 bytes each) in an L4S AC_VI queue (e.g., third AC L4S queue 166) at a time 't0', then sends a BSR indicating 4 packets at a later time 't1', then sends a BSR indicating 2 packets at a later time 't2', then sends a BSR indicating 4 packets at a later time 't3', etc. Meanwhile of course, the STA is transmitting data; thus, the packets in the queue are not new packets. In this scenario, the AP could learn the STAs transmit pattern (e.g., 2-4-2-4 . . . ) such that the AP could pre-allocate RUs/TXOPs according to the 2, then 4, then 2 then 4, etc. pattern at each future interval for the STA.

In at least one embodiment, BSR L4S queue status techniques provided herein may be utilized, realized, or otherwise implemented for IEEE 802.11bn standards, and/or any other 802.11 standards.

Accordingly, embodiments herein provide techniques through which enhanced BSRs can be utilized for reporting L4S queue status and also potentially non-L4S queue status.

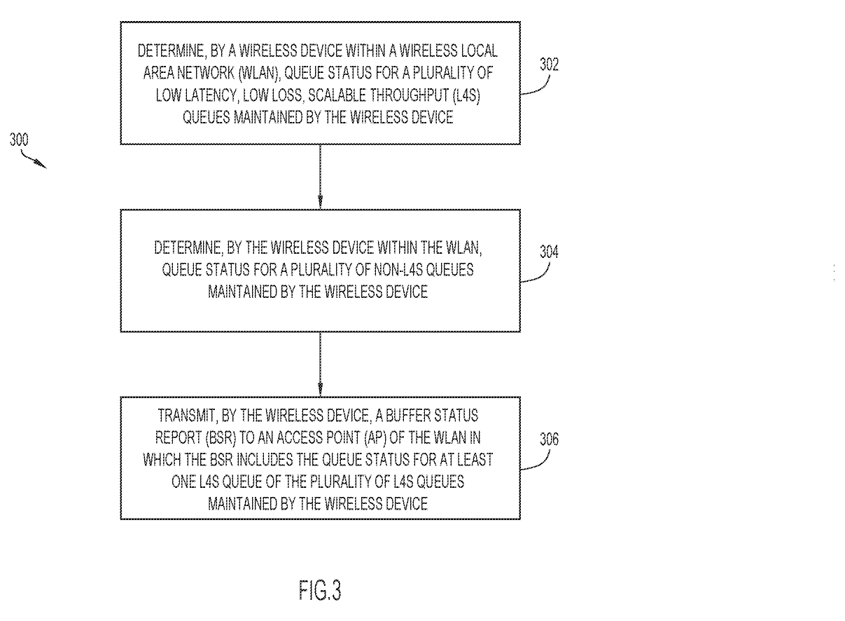

Referring to FIG. 3, FIG. 3 is a flowchart depicting a method 300 according to an example embodiment. In at least one embodiment, method 300 illustrates example operations that may be performed by a wireless device of a WLAN (e.g., any of STA 104-1 through 104-M) for reporting at least L4S queue status for at least one L4S queue via at least one enhanced BSR in accordance with embodiments herein.

At 302, the method may include determining, by a wireless device within a wireless local area network (WLAN), queue status for a plurality of Low Latency, Low Loss, Scalable Throughput (L4S) queues maintained by the wireless device. As shown at 304, the method may include determining, by the wireless device within the WLAN, queue status for a plurality of non-L4S queues maintained by the wireless device.

As shown at 306, the method may include transmitting, by the wireless device, a buffer status report (BSR) to an access point (AP) of the WLAN in which the BSR includes the queue status for at least one L4S queue of the plurality of L4S queues maintained by the wireless device.

In one instance, the queue status for the at least one L4S queue is a queue size for the at least one L4S queue. In one instance, each of the plurality of L4S queues maintained by the wireless device corresponds to a different access category (AC). In one instance, each of the plurality of non-L4S queues maintained by the wireless device corresponds to a different access category (AC).

In one instance, the transmitting includes transmitting the BSR to the AP of the WLAN as a solicited BSR, based on obtaining a BSR poll by the wireless device from AP of the WLAN. In one instance, the transmitting includes transmitting the BSR as an unsolicited BSR. In one instance, the BSR poll indicates a request for the queue status for the at least one L4S queue (e.g., an enhanced BSR poll). In one instance, the BSR poll is a traditional (unenhanced) BSR poll.

In one instance, the queue status for the at least one L4S queue is indicated in a field of the BSR. In one instance, the BSR further includes the queue status for at least one non-L4S queue of the plurality of non-L4S queues. In one instance, the queue status for the at least one non-L4S queue is included in the field of the BSR.

In one instance, the BSR includes one or more enhanced fields of an existing aggregated control (A-Control) BSR control subfield variant. In one instance, BSR is a new aggregated control (A-Control) BSR control subfield variant.

In various instances, the queue status comprises at least one of: an amount of data contained in the at least one L4S queue and an access category (AC) for the at least one L4S queue; an amount of data contained in at least one non-L4S queue of the plurality of non-L4S queues an access category (AC) and for the at least one non-L4S queue; an amount of data overwritten in the at least one L4S queue for a period of time; a number of transmission control protocol (TCP) acknowledgments or a number of Quick User Datagram Protocol (UDP) Internet Connections (QUIC) packets that have been marked with a congestion indication by the wireless device; a number of packets, bytes, or octets received or sent for the at least one L4S queue for an interval of time; or a number of packets marked with a congestion indication by the wireless device for the at least one L4S queue for an interval of time.

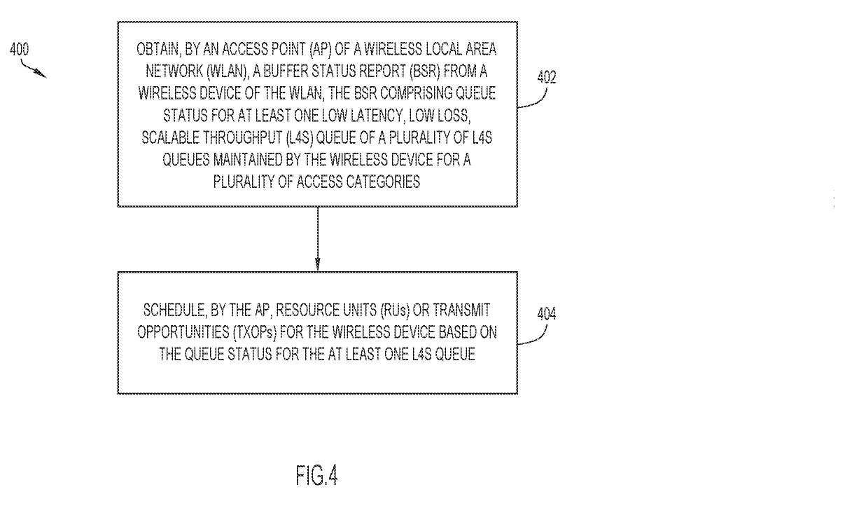

Referring to FIG. 4, FIG. 4 is a flowchart depicting a method 400 according to an example embodiment. In at least one embodiment, method 400 illustrates example operations that may be performed by an access point of a WLAN (e.g., any of AP 102-1 through 102-N) for obtaining at least one enhanced BSR reporting at least L4S queue status for at least one L4S queue in accordance with embodiments herein.

At 402, the method can include obtaining, by an access point (AP) of a wireless local area network (WLAN), a buffer status report (BSR) from a wireless device of the WLAN, the BSR comprising queue status for at least one Low Latency, Low Loss, Scalable Throughput (L4S) queue of a plurality of L4S queues maintained by the wireless device for a plurality of access categories.

At 404, the method can include scheduling, by the AP, Resource Units (RUs) or Transmit Opportunities (TXOPs) for the wireless device based on the queue status for the at least one L4S queue. In one instance, the scheduling can include scheduling wider RUs for the wireless device based on the queue status for the at least one L4S queue (e.g., if the L4S queue is filling up or if data in the L4S queue is being overwritten). In one instance, the scheduling can include scheduling more TXOPs for the wireless device based on the queue status for the at least one L4S queue (e.g., if the L4S queue is filling up or if data in the L4S queue is being overwritten).

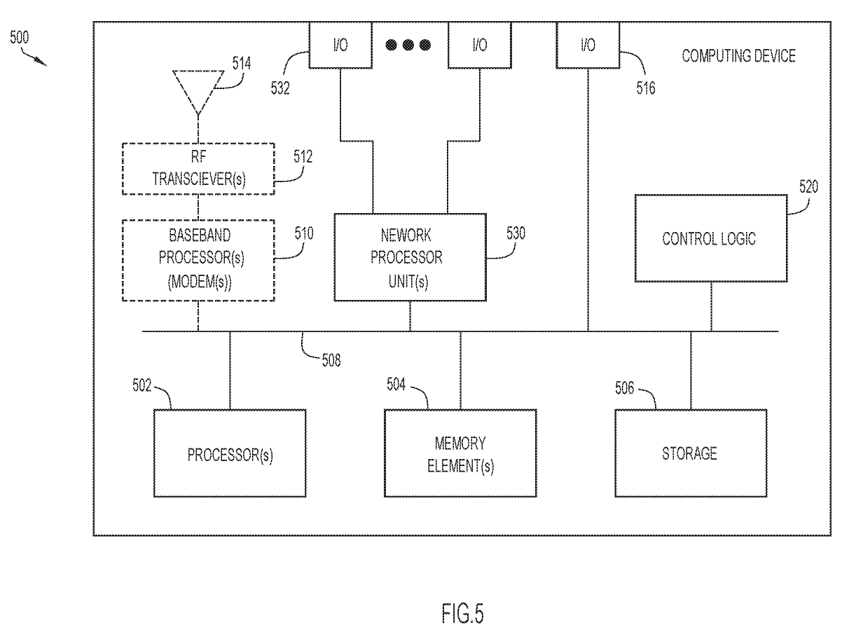

Referring to FIG. 5, FIG. 5 illustrates a hardware block diagram of a computing device 500 that may perform functions associated with operations discussed herein in connection with the techniques described for embodiments herein. In various embodiments, a computing device or apparatus, such as computing device 500 or any combination of computing devices 500, may be configured as any entity/entities in order to perform operations of the various techniques discussed for embodiments herein, such as any elements, functions, etc. discussed for embodiments herein (e.g., an AP, a STA, a wireless network controller, etc.).

In at least one embodiment, the computing device 500 may be any apparatus that may include one or more processor(s) 502, one or more memory element(s) 504, storage 506, a bus 508, one or more network processor unit(s) 530 interconnected with one or more network input/output (I/O) interface(s) 532, one or more I/O interface(s) 516, and control logic 520. In various embodiments, instructions associated with logic for computing device 500 can overlap in any manner and are not limited to the specific allocation of instructions and/or operations described herein.

Computing device 500 may further include at least one baseband processor or modem 510, one or more radio RF transceiver(s) 512 (e.g., any combination of RF receiver(s) and RF transmitter(s)), one or more antenna(s) or antenna array(s) 514 (which may be inclusive of software-defined antenna(s) or antenna array(s)) in accordance with embodiments herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa) or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 530 may enable communication between computing device 500 and other systems, entities, etc., via network I/O interface(s) 532 (wired and/or wireless) to facilitate operations discussed for various embodiments described herein. In various embodiments, network processor unit(s) 530 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 532 can be configured as one or more Ethernet port(s), Fibre Channel ports, any other I/O port(s), and/or antenna(s)/antenna array(s) now known or hereafter developed. Thus, the network processor unit(s) 530 and/or network I/O interface(s) 532 may include suitable interfaces for receiving, transmitting, and/or otherwise communicating data and/or information (wired and/or wirelessly) in a network environment.

I/O interface(s) 516 allow for input and output of data and/or information with other entities that may be connected to computing device 500. For example, I/O interface(s) 516 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 512 may perform RF transmission and RF reception of wireless signals via antenna(s)/antenna array(s) 514, and the baseband processor or modem 510 performs baseband modulation and demodulation, etc. associated with such signals to enable wireless communications for computing device 500.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include a method as shown and described herein. In one form an apparatus as shown and described herein is provided. In one form, a system as shown and described herein is provided. In one form, one or more computer readable storage media encoded with software comprising computer executable instructions is/are provided herein that, when the software, is/are executed operable to perform operations as shown and described herein.

In some aspects, the techniques described herein relate to a method including: determining, by a wireless device within a wireless local area network (WLAN), queue status for a plurality of Low Latency, Low Loss, Scalable Throughput (L4S) queues maintained by the wireless device; determining, by the wireless device within the WLAN, queue status for a plurality of non-L4S queues maintained by the wireless device; and transmitting a buffer status report (BSR) to an access point (AP) of the WLAN, the BSR including the queue status for at least one L4S queue of the plurality of L4S queues maintained by the wireless device.

In some aspects, the techniques described herein relate to a method, wherein the queue status for the at least one L4S queue is a queue size for the at least one L4S queue.

In some aspects, the techniques described herein relate to a method, wherein each of the plurality of L4S queues maintained by the wireless device corresponds to a different access category (AC).

In some aspects, the techniques described herein relate to a method, wherein each of the plurality of non-L4S queues maintained by the wireless device corresponds to a different access category (AC).

In some aspects, the techniques described herein relate to a method, wherein the transmitting includes transmitting the BSR to the AP of the WLAN as a solicited BSR, based on obtaining a BSR poll by the wireless device from AP of the WLAN, or transmitting the BSR as an unsolicited BSR.

In some aspects, the techniques described herein relate to a method, wherein the BSR poll indicates a request for the queue status for the at least one L4S queue.

In some aspects, the techniques described herein relate to a method, wherein the queue status for the at least one L4S queue is indicated in a field of the BSR.

In some aspects, the techniques described herein relate to a method, wherein the BSR further includes the queue status for at least one non-L4S queue of the plurality of non-L4S queues.

In some aspects, the techniques described herein relate to a method, wherein the queue status for the at least one non-L4S queue is included in the field of the BSR.

In some aspects, the techniques described herein relate to a method, wherein the BSR includes one or more enhanced fields of an existing aggregated control (A-Control) BSR .

In some aspects, the techniques described herein relate to a method, wherein BSR is a new aggregated control (A-Control) BSR.

In some aspects, the techniques described herein relate to a method, wherein the queue status includes at least one of: an amount of data contained in the at least one L4S queue and an access category (AC) for the at least one L4S queue; an amount of data contained in at least one non-L4S queue of the plurality of non-L4S queues an access category (AC) and for the at least one non-L4S queue; an amount of data overwritten in the at least one L4S queue for a period of time; a number of transmission control protocol (TCP) acknowledgments or a number of Quick User Datagram Protocol (UDP) Internet Connections (QUIC) packets that have been marked with a congestion indication by the wireless device; a number of packets, bytes, or octets received or sent for the at least one L4S queue for an interval of time; or a number of packets marked with a congestion indication by the wireless device for the at least one L4S queue for an interval of time.

In some aspects, the techniques described herein relate to a method including: obtaining, by an access point (AP) of a wireless local area network (WLAN), a buffer status report (BSR) from a wireless device of the WLAN, the BSR including queue status for at least one Low Latency, Low Loss, Scalable Throughput (L4S) queue of a plurality of L4S queues maintained by the wireless device for a plurality of access categories; and scheduling, by the AP, Resource Units (RUs) or Transmit Opportunities (TXOPs) for the wireless device based on the queue status for the at least one L4S queue.

In some aspects, the techniques described herein relate to a method, wherein the scheduling includes providing wider RUs for the wireless device based on the queue status for the at least one L4S queue.

In some aspects, the techniques described herein relate to a method, wherein the scheduling includes scheduling more TXOPs for the wireless device based on the queue status for the at least one L4S queue.

In some aspects, the techniques described herein relate to a method, further including: obtaining a plurality of BSRs from the wireless device including the queue status for the at least one L4S queue; and maintaining a time-series indication of the queue status for the at least one L4S queue for tracking at least one of changes or a rate-of-changes in L4S behavior of the wireless device.

In some aspects, the techniques described herein relate to a wireless device including: at least one memory element for storing data; and at least one processor for executing instructions associated with the data, wherein executing the instructions causes the wireless device to perform operations, including: determining, by a wireless device within a wireless local area network (WLAN), queue status for a plurality of Low Latency, Low Loss, Scalable Throughput (L4S) queues maintained by the wireless device; determining, by the wireless device within the WLAN, queue status for a plurality of non-L4S queues maintained by the wireless device; and transmitting a buffer status report (BSR) to an access point (AP) of the WLAN, the BSR including the queue status for at least one L4S queue of the plurality of L4S queues maintained by the wireless device.

In some aspects, the techniques described herein relate to a wireless device, wherein each of the plurality of L4S queues maintained by the wireless device corresponds to a different access category (AC).

In some aspects, the techniques described herein relate to a wireless device, wherein the BSR includes one or more enhanced fields of an existing aggregated control (A-Control) BSR.

In some aspects, the techniques described herein relate to a wireless device, wherein the queue status includes at least one of: an amount of data contained in the at least one L4S queue and an access category (AC) for the at least one L4S queue; an amount of data contained in at least one non-L4S queue of the plurality of non-L4S queues an access category (AC) and for the at least one non-L4S queue; an amount of data overwritten in the at least one L4S queue for a period of time; a number of transmission control protocol (TCP) acknowledgments or a number of Quick User Datagram Protocol (UDP) Internet Connections (QUIC) packets that have been marked with a congestion indication by the wireless device; a number of packets, bytes, or octets received or sent for the at least one L4S queue for an interval of time; or a number of packets marked with a congestion indication by the wireless device for the at least one L4S queue for an interval of time.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
determining, by a wireless device within a wireless local area network (WLAN), queue status for a plurality of Low Latency, Low Loss, Scalable Throughput (L4S) queues maintained by the wireless device;
determining, by the wireless device within the WLAN, queue status for a plurality of non-L4S queues maintained by the wireless device; and
transmitting a buffer status report (BSR) to an access point (AP) of the WLAN, the BSR comprising the queue status for at least one L4S queue of the plurality of L4S queues maintained by the wireless device.

2. The method of claim 1, wherein the queue status for the at least one L4S queue is a queue size for the at least one L4S queue.

3. The method of claim 1, wherein each of the plurality of L4S queues maintained by the wireless device corresponds to a different access category (AC).

4. The method of claim 1, wherein each of the plurality of non-L4S queues maintained by the wireless device corresponds to a different access category (AC).

5. The method of claim 1, wherein the transmitting includes transmitting the BSR to the AP of the WLAN as a solicited BSR, based on obtaining a BSR poll by the wireless device from AP of the WLAN, or transmitting the BSR as an unsolicited BSR.

6. The method of claim 5, wherein the BSR poll indicates a request for the queue status for the at least one L4S queue.

7. The method of claim 1, wherein the queue status for the at least one L4S queue is indicated in a field of the BSR.

8. The method of claim 7, wherein the BSR further includes the queue status for at least one non-L4S queue of the plurality of non-L4S queues.

9. The method of claim 8, wherein the queue status for the at least one non-L4S queue is included in the field of the BSR.

10. The method of claim 1, wherein the BSR includes one or more enhanced fields of an existing aggregated control (A-Control) BSR .

11. The method of claim 1, wherein BSR is a new aggregated control (A-Control) BSR.

12. The method of claim 1, wherein the queue status comprises at least one of:
an amount of data contained in the at least one L4S queue and an access category (AC) for the at least one L4S queue;
an amount of data contained in at least one non-L4S queue of the plurality of non-L4S queues an access category (AC) and for the at least one non-L4S queue;
an amount of data overwritten in the at least one L4S queue for a period of time;
a number of transmission control protocol (TCP) acknowledgments or a number of Quick User Datagram Protocol (UDP) Internet Connections (QUIC) packets that have been marked with a congestion indication by the wireless device;
a number of packets, bytes, or octets received or sent for the at least one L4S queue for an interval of time; or
a number of packets marked with a congestion indication by the wireless device for the at least one L4S queue for an interval of time.

13. A method comprising:
obtaining, by an access point (AP) of a wireless local area network (WLAN), a buffer status report (BSR) from a wireless device of the WLAN, the BSR comprising queue status for at least one Low Latency, Low Loss, Scalable Throughput (L4S) queue of a plurality of L4S queues maintained by the wireless device for a plurality of access categories; and
scheduling, by the AP, Resource Units (RUs) or Transmit Opportunities (TXOPs) for the wireless device based on the queue status for the at least one L4S queue.

14. The method of claim 13, wherein the scheduling includes providing wider RUs for the wireless device based on the queue status for the at least one L4S queue.

15. The method of claim 13, wherein the scheduling includes scheduling more TXOPs for the wireless device based on the queue status for the at least one L4S queue.

16. The method of claim 13, further comprising:
obtaining a plurality of BSRs from the wireless device including the queue status for the at least one L4S queue; and
maintaining a time-series indication of the queue status for the at least one L4S queue for tracking at least one of changes or a rate-of-changes in L4S behavior of the wireless device.

17. A wireless device comprising:
at least one memory element for storing data; and
at least one processor for executing instructions associated with the data, wherein executing the instructions causes the wireless device to perform operations, comprising:
determining, by a wireless device within a wireless local area network (WLAN), queue status for a plurality of Low Latency, Low Loss, Scalable Throughput (L4S) queues maintained by the wireless device;
determining, by the wireless device within the WLAN, queue status for a plurality of non-L4S queues maintained by the wireless device; and
transmitting a buffer status report (BSR) to an access point (AP) of the WLAN, the BSR comprising the queue status for at least one L4S queue of the plurality of L4S queues maintained by the wireless device.

18. The wireless device of claim 17, wherein each of the plurality of L4S queues maintained by the wireless device corresponds to a different access category (AC).

19. The wireless device of claim 17, wherein the BSR includes one or more enhanced fields of an existing aggregated control (A-Control) BSR.

20. The wireless device of claim 17, wherein the queue status comprises at least one of:
an amount of data contained in the at least one L4S queue and an access category (AC) for the at least one L4S queue;
an amount of data contained in at least one non-L4S queue of the plurality of non-L4S queues an access category (AC) and for the at least one non-L4S queue;
an amount of data overwritten in the at least one L4S queue for a period of time;
a number of transmission control protocol (TCP) acknowledgments or a number of Quick User Datagram Protocol (UDP) Internet Connections (QUIC) packets that have been marked with a congestion indication by the wireless device;
a number of packets, bytes, or octets received or sent for the at least one L4S queue for an interval of time; or
a number of packets marked with a congestion indication by the wireless device for the at least one L4S queue for an interval of time.
